(19) United States
(12) Patent Application Publication
(10) Pub. No.: US 2024/0330716 A1
(43) Pub. Date: Oct. 3, 2024

(54) METHOD AND SYSTEM OF EFFICIENT ONTOLOGY MATCHING

(71) Applicant: NEC Laboratories Europe GmbH, Heidelberg (DE)

(72) Inventors: Bin CHENG, Heidelberg (DE); Jonathan FUERST, Heidelberg (DE)

(21) Appl. No.: 18/577,285

(22) PCT Filed: Dec. 9, 2021
(86) PCT No.: PCT/EP2021/085091

§ 371 Date: Jan. 8, 2024

(30) Foreign Application Priority Data
Sep. 7, 2021 (EP) 21195268.4

(51) Int. Cl. G06N 5/022; G06N 20/00

(52) U.S. Cl. CPC G06N 5/022; G06N 20/00

(57) ABSTRACT

A method for ontology matching between a source and a target filters out non-matching pairs of the source and the target, to generate a dataset of possible matches. In a first loop, based on prediction results and uncertainty from a set of labeling functions of a labeling function (LF) committee, a data point is selected from the dataset and an annotation label is obtained for the data point. Additionally, labeling functions of the LF committee are selected and weighted based on prediction results against the dataset provided with annotation labels, and a weight of each of the selected LFs is adjusted to produce the prediction results and uncertainty of yet unlabeled data points of the dataset based on the data points of the dataset having already annotated a label. A second learning loop is executed that creates tuned labeling functions and augments the LF committee with the tuned labeling functions.

### CROSS REFERENCE TO RELATED APPLICATIONS

This application is a U.S. National Phase application under 35 U.S.C. § 371 of International Application No. PCT/EP2021/085091, filed on Dec. 9, 2021, and claims benefit to European Patent Application No. EP 21195268.4, filed on Sep. 7, 2021. The International Application was published in English on Mar. 16, 2023 as WO 2023/036453 A1 under PCT Article 21 (2).

### FIELD

The present invention relates to a computer-implemented method and system for efficient ontology matching between a source ontology and a target ontology.

### BACKGROUND

Ontologies are a formal way of representing classes and their relations in the form of triples to describe knowledge that could be reused and shared across systems and domains. Nowadays, ontologies play an import role in data integration (for reference, see Gao, J.; Ploennigs, J.; and Berges, M. 2015. A data-driven meta-data inference framework for building automation systems. In Proceedings of the 2nd ACM International Conference on Embedded Systems for Energy-Efficient Built Environments, 23-32) and knowledge-based reasoning (for reference, see Hohenecker, P.; and Lukasiewicz, T. 2020. Ontology reasoning with deep neural networks. In Journal of Artificial Intelligence Research 68:503-540). For example, enterprises can leverage a domain-specific ontology to align the schema of their heterogeneous data sources into a common knowledge graph for better information sharing; on top of the aligned and integrated knowledge information, ontology can be further utilized to support knowledge-based reasoning to answer complex questions.

Although there is an increasing demand on domain-specific ontologies, creating a backbone ontology per domain or company at scale (as described, e.g., in Ochieng, P.; and Kyanda, S. 2018. Large-scale ontology matching: state-of-the-art analysis. ACM Computing Surveys (CSUR) 51 (4): 1-35) is still a big challenge because it usually requires lots of human effort to carefully define and confirm all concepts and their relationships for high quality and coverage. Fortunately, a backbone ontology does not need to be created from scratch in many cases. Instead, it can be constructed incrementally by integrating existing ontologies with good quality and high coverage. Ontology matching (as described, e.g., in Shvaiko, P.; and Euzenat, J. 2011. Ontology matching: state of the art and future challenges. IEEE Transactions on knowledge and data engineering 25 (1): 158-176) is a crucial task to help domain experts speed up this ontology integration process by identifying the same concepts between two ontologies. Since the backbone ontology plays a central role for company-wide data integration and analytics, it still may be necessary to ask domain experts to check and confirm all predicted matches so that duplicated concepts can be annotated within the backbone ontology.

Existing ontology matching algorithms, e.g., AML (for reference, see Faria, D.; Pesquita, C.; Santos, E.; Palmonari, M.; Cruz, I. F.; and Couto, F. M. 2013. The agreementmakerlight ontology matching system. In OTM Confederated International Conferences “On the Move to Meaningful Internet Systems”, 527-541. Springer), Log Map (for reference, see Jiménez-Ruiz, E.; and Grau, B. C. 2011. Log map: Logic-based and scalable ontology matching. In International Semantic Web Conference, 273-288. Springer), and Yam++ (for reference, see Ngo, D.; and Bellahsene, Z. 2012. YAM++: a multi-strategy based approach for ontology matching task. In International Conference on Knowledge Engineering and Knowledge Management, 421-425. Springer) can help to predict a set of matched classes with low risk, but they are limited in their efficiency of identifying as many matches as possible. Also, their prediction performance either relies on lots of labeled data for training or requires sophisticated heuristics to work well. In addition, their performance can vary largely across different ontology datasets.

To overcome the limitations of learning- or heuristic-based matching algorithms, the idea of engaging humans in the learning loop to annotate a few samples has been explored. Active learning selects a few samples based on uncertainty sampling and then asks domain experts to label them to train a classifier. However, existing active learning approaches fail to bootstrap the learning capability due to a random selection strategy at the beginning. This is even worse when dealing with the extreme class imbalance for ontology matching, because the number of matched classes is low, usually less than 0.1% of all possible class pairs. This is like looking for a needle in a haystack.

Recently, data programming has been proposed as a weak supervision approach to generate weak labels out of unlabeled data for training machine learning models, only based on a set of rule- or heuristic-based labeling functions that could be easily programmed by users. Further studies like WeSAL [Nashaat, Mona, Aindrila Ghosh, James Miller, and Shaikh Quader “WeSAL: Applying active supervision to find high-quality labels at industrial scale.” In Proceedings of the 53rd Hawaii International Conference on System Sciences. 2020.] and Active WeaSuL [Biegel, Samantha, Rafah El-Khatib, Luiz Otavio Vilas Boas Oliveira, Max Baak, and Nanne Aben. “Active WeaSuL: Improving Weak Supervision with Active Learning.” arXiv preprint arXiv: 2104.14847 (2021).] further leverage the idea of active learning to improve the quality of weak labels generated by data programming.

However, those approaches are not efficient for ontology matching because they have limited capability to discover potential true matches and also to deal with extreme imbalanced data. The performance is measured by the total amount of required human effort in finding the same number of true matches and lower effort means high efficiency. The performance of existing approaches is not satisfying when the target is to find as many matches as possible with an affordable effort.

US 2017/0084197 A1 discloses a system and method of automatically distilling concepts from math problems and testing the creation of math problems from a collection of concepts. The system allows the user to input the problem with a user data packet that can contain attributes, properties, and variables that may describe a math skill set. This math problem is further matched with multiple concept line items (CLIs) stored in a database with the help of Ontology architecture and a check whether the problem can be related to an already stored problem or not. Further, the system performs parallel matching with help of two modules that help to extract the concepts of the problems. The system allows the interaction of experts during the data extraction process and filters the experts as per the requirement.

U.S. Pat. No. 8,874,552 B2 discloses a method for automated generation of ontologies. The process includes defining an ontology pertaining to a given sphere of knowledge. A computer receives a search query generated using the ontology and provides to a user of the computer at least one document in response to the query. The computer receives tags that the user has associated with data elements in the at least one document and automatically updates the ontology responsively to the tags.

### SUMMARY

In an embodiment, the present disclosure provides a computer-implemented method for efficient ontology matching between a source ontology and a target ontology. The method comprises filtering out, by an adaptive blocking mechanism, non-matching pairs of the source ontology and the target ontology, thereby generating an initially unlabeled dataset U of possible matches; selecting, in each iteration of a first learning loop and based on prediction results and uncertainty from a set of initially provided labeling functions of a labeling function (LF) committee, a data point from the unlabeled dataset U and obtaining an annotation label for the selected data point; selecting and weighting, in each iteration of the first learning loop, a set of labeling functions out of the LF committee based on their prediction results against the unlabeled dataset U provided with annotation labels so far and adjusting a weight of each of the selected LFs to produce the prediction results and uncertainty of yet unlabeled data points of the unlabeled dataset U based on the data points of the unlabeled dataset U having already annotated a label; and executing a second learning loop that automatically creates tuned labeling functions and augments the LF committee with the tuned labeling functions.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a diagram illustrating a simplified example of using a backbone ontology as integration point for two different ontologies;

FIG. 2 is a schematic view illustrating a system for efficient ontology matching with two parallel learning loops in accordance with an embodiment of the present invention;

FIG. 3 illustrates an example of an adaptive blocking approach as used in accordance with an embodiment of the present invention;

FIG. 4 is a diagram illustrating the performance of a top-x adaptive blocking approach with various number of distant features as used in accordance with embodiments of the present invention;

FIG. 5 is a diagram comparing the performance of different blocking algorithms as used in accordance with embodiments of the present invention;

FIG. 6 illustrates an example of a tunable labeling function based on the distance feature calculated from class name as used in accordance with an embodiment of the present invention;

FIG. 7 illustrates an example of an automated threshold tuning approach for LF augmentation as used in accordance with an embodiment of the present invention; and

FIG. 8 is a diagram illustrating the performance of ontology matching according to embodiments of the present invention compared to existing prior art solutions.

### DETAILED DESCRIPTION

In accordance with an embodiment, the present invention improves and further develops a method and a system of the initially described type for ontology matching in such a way that the bootstrapping capability and the efficiency of the exploration capability are improved.

In accordance with another embodiment, the present invention provides a computer-implemented method for efficient ontology matching between a source ontology and a target ontology, the method comprising: filtering out, by means of an adaptive blocking mechanism, non-matching pairs of the source and the target ontology, thereby generating an initially unlabeled dataset U of possible matches; selecting, in each iteration of a first learning loop and based on prediction results and uncertainty from a set of initially provided labeling functions of a labeling function, LF, committee, a data point from the dataset U and obtaining an annotation label for the selected data point; selecting and weighting, in each iteration of the first learning loop, a set of labeling functions out of the LF committee based on their prediction results against the dataset U provided with annotation labels so far and adjusting a weight of each of the selected LFs to produce the prediction results and uncertainty of yet unlabeled data points of dataset U based on the data points of dataset U having already annotated a label; and executing a second learning loop that automatically creates tuned labeling functions and augments the LF committee with the tuned labeling functions.

According to the invention, it has been recognized that ontology matching is a crucial task to create high quality backbone ontologies for data integration/harmonization. To address the issues of existing solutions of being inefficient due to limited learning capabilities over annotated data, embodiments of the present invention provide a method and system of efficient ontology matching with two collaborative learning loops to find more matches faster at lower cost.

According to embodiments, the method/system uses two separate loops, one is a fast loop, which may be performed online, e.g. for interaction with domain experts, with faster speed and short delay, whereas the slow loop may be a background learning loop that is executed in parallel to create new labeling functions for the augmentation and update of voting results. Before these parallel loops are executed, an adaptive blocking approach may be used to reduce the number of candidates so that the fast and slow loop can efficiently execute their algorithms with lower computation overhead. Further, according to embodiments, the method/system may utilize tunable labeling functions, which can be changed at any time based on performance metrics and coverage. The advantage of the parallel running loops is to maintain the speed and accuracy of the ontology matching in which one loop can perform faster calculations and the other loop can dig in deeper but at slow speed, then combining these loops to match the final results.

According to an embodiment of the present invention, the second learning loop may be implemented as a background learning loop that runs in parallel and collaboratively with the first learning loop. While the fast loop should be computation efficient, the slow loop could be implemented to perform heavy computation with long time interval, for example including training/retraining of machine learning models. Both loops may run with different time intervals and speeds.

According to embodiments of the invention, the two learning loops may be terminated upon reaching an overall cost including a cost component related to an annotation of the selected data points and a cost component related to a verification of predicted true matches.

According to an embodiment of the invention, the adaptive blocking mechanism may be configured to use a change point detection algorithm applied to a sequence of data points ranked according to a predefined distance feature.

According to an embodiment of the invention, selecting data points from the dataset U in the fast loop may be based on both the sample diversity (e.g., for exploring new learning opportunities) and class imbalance (e.g., for reducing the risk).

According to embodiments of the invention, the dataset U may be generated such that each data point of the dataset U is an initially unlabeled data point dᵢⱼ including a predicted result pᵢⱼ that an element eᵢ of source matches with an element eⱼ of target ontology and its prediction uncertainty cᵢⱼ estimated via a learned generative model. In this context, it may be provided that the selecting, in each iteration of the first learning loop and based on prediction results and uncertainty from the set of initially provided labeling functions of the labeling function, LF, committee, a data point from the dataset U includes the following steps: 1) grouping the data points dᵢⱼ of the dataset U into a number of different groups based on a number of predicted true votes from the set of initially provided labeling functions; and (2) selecting the group with the highest number of true votes and, within the selected group, picking up for annotation the data point having the highest uncertainty cᵢⱼ.

According to an embodiment of the invention, an LF ensembler component may be implemented within the learning loops that combines voting results vᵢⱼ^{q} (1≤q≤m) from a set of labeling functions {lf₁, lf₂, . . . , lfₘ} to predict matching results of all data points of the dataset U and to estimate an uncertainty of the predicted results.

According to an embodiment of the invention, the LF ensembler component may further execute the following steps: (1) applying a predefined heuristic to select a subset of labeling functions out of the LF committee based on the annotation data obtained so far; and (2) estimating the precision of the labeling functions of the selected subset based on the annotation data obtained so far and then adjusting the weight of each labeling function of the selected subset based on its estimated precision for training of a LF ensembler component's learning model.

According to embodiments of the invention, the creation of tuned LFs includes a generation of new LFs and/or an update of already existing LFs.

According to embodiments of the invention, tunable labeling functions may be used to create new labeling functions and/or to update already existing labeling functions on the fly by automatically tuning a predefined distance-related threshold based on the latest annotation data and prediction results. In this context, it may be provided that each tunable labeling function relies on a tunable threshold parameter and a predefined similarity feature to decide whether a candidate dᵢⱼ in U is a match or not based on a predefined logic.

According to embodiments of the invention, the predefined similarity feature may be configured to measure similarity based on any of the following methods:
(1) using a pre-trained sentence transformer model measuring a semantic similarity of string-based attributes of the classes eᵢ, eⱼ;
(2) using a predicted matching probability of a machine learning model that is trained/retrained from all prepared features based on the latest annotation data and prediction results; and/or
(3) using a knowledge graph embedding model that is trained/retrained from a temporary graph that combines the source ontology and the target ontology as well as new edges represented by all annotated and predicted matches.

There are several ways how to design and further develop the teaching of the present invention in an advantageous way. To this end, it is to be referred to the dependent claims on the one hand and to the following explanation of preferred embodiments of the invention by way of example, illustrated by the figure on the other hand. In connection with the explanation of the preferred embodiments of the invention by the aid of the figure, generally preferred embodiments and further developments of the teaching will be explained.

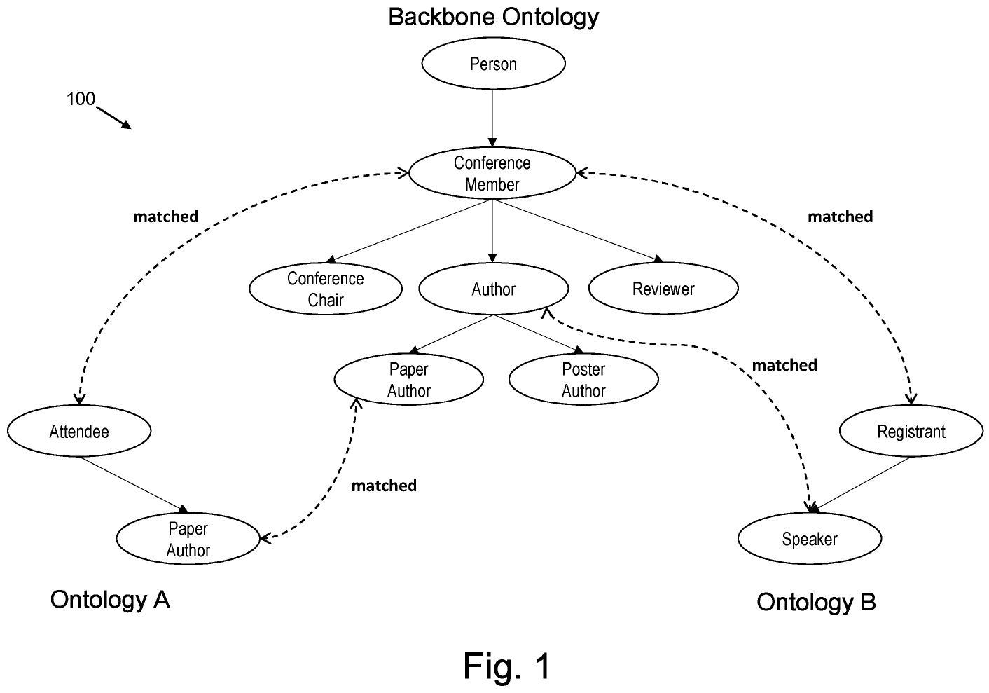

Backbone ontology serves as the integration point for multiple ontologies of a domain. The choice of backbone ontology might be based on agreed standards or application needs. As shown in FIG. 1, to build up a comprehensive backbone ontology 100, one can initialize the backbone ontology 100 with some existing ontology in the selected domain and then incrementally expand its coverage by matching other relevant ontologies (e.g. ontology A and ontology B, according to the illustrated embodiment) to this common backbone ontology.

Since the backbone ontology 100 usually plays a central role for a broad range of scenarios, such as data integration and discovery, service alignment and interoperability, knowledge-based reasoning, it is essential to ensure high quality of integrated knowledge within the backbone ontology 100 even after the integration process. Therefore, it may be necessary to verify all matched classes to avoid any ambiguity.

Each ontology defines a conceptualization of a domain with classes (representing domain concepts), literal values (such as comments and labels), individuals (instances of classes) and properties. Properties can define relations between classes/instances (object properties) and relations between a class/instance and a literal (data property), thus defining the attributes. Classes can have super and sub-class relations, defining a hierarchical structure. Subclasses inherit all properties of their parent classes. Additionally, different constraints can be associated with a class (e.g., Class A≠Class B).

The interactive ontology matching is performed to find more mappings of classes/properties between a source ontology S and a target ontology T with affordable human effort. Such mappings can be of different meaning and complexity: equality, subsumption and supersumption correspondence. The present invention focuses on the equality mapping of classes between S and T. Therefore, in accordance with embodiments of the invention a matching is an equality mapped class pair represented by (eᵢ, eⱼ, p, c), where eᵢ is a class from the source ontology S, eᵢ is a class from the target ontology T, and p and c are the predicted result and its prediction uncertainty obtained by ontology matching.

The challenges to design an efficient interactive ontology matching include: 1) how to narrow down the large set of matching candidates without missing any possible true matches to engage domain experts? 2) how to engage domain experts efficiently to find more matches with lower human effort? 3) how to ensure fast response time to have smooth experiment for user interaction?

Embodiments of the present invention provide an efficient learning-based ontology matching approach that addresses the above issues. According to one aspect, the approach applies an adaptive blocking method based on change point detection to speed up the learning process by largely reducing candidates without missing true matches. According to an alternative or additional aspect, the approach automatically generates and tunes labeling functions to prepare a dynamically updated voting committee for predicting the matching results and their confidence of unlabeled candidates. According to still another aspect, the approach implements collaborative but separated learning loops for user annotation and new labeling function exploration. Hereinafter, the above aspects will be described in more detail.

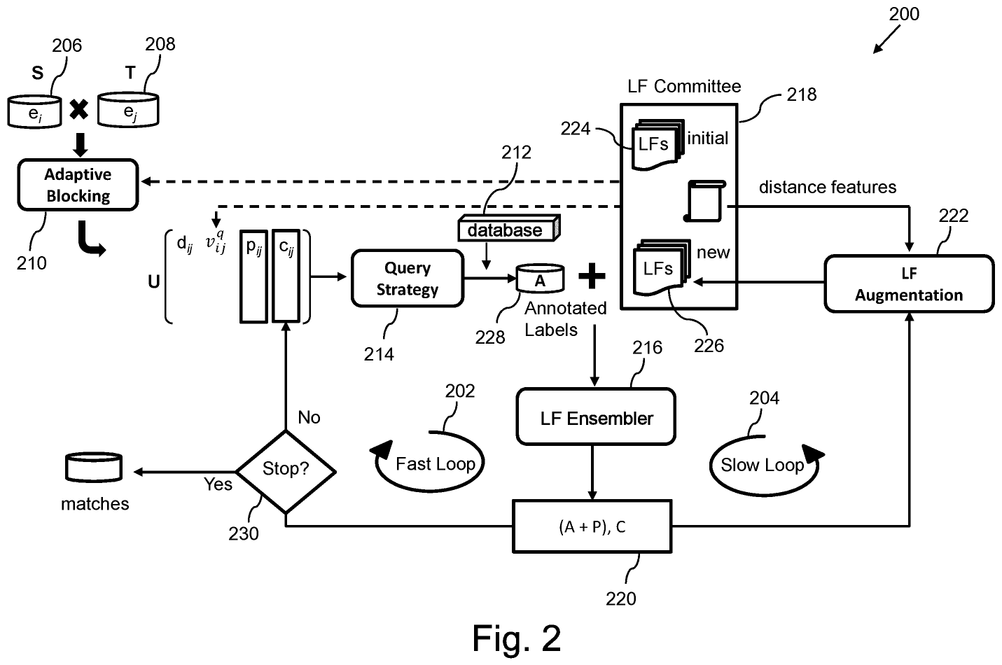

According to embodiments of the invention, as shown in the high-level workflow of FIG. 2, the learning-based ontology matching system 200 includes two collaborative, but paralleled learning loops 202, 204 to help domain experts to efficiently find more matched classes between a source ontology 206 (S) and a target ontology 208 (T). In the illustrated scenario of building up high quality backbone ontology via ontology matching, the targets of achieving higher efficiency could be further interpreted from three perspectives: 1) identifying the same number of true matches with lower human effort; 2) being able to identify more true matches with the same amount of human effort; 3) the response time for domain experts to receive the next round of suggested matches should be lower, at least under an acceptable delay.

As illustrated in FIG. 2, given source ontology S and a target ontology T, an adaptive blocking algorithm 210 may be carried out to filter out as many non-matches (eᵢ#eⱼ, eᵢ∈S, eⱼ∈T) as possible without losing any true matches. All remaining class pairs that pass through the blocking process may be considered as possible matches to be further utilized in a following learning phase.

However, all remaining class pairs are still not labelled yet and it is unknown whether they are true matches or not. They form an unlabeled dataset U and each data point in U is an unlabeled data point dᵢⱼ with two estimations: the predicted result pᵢⱼ and its prediction uncertainty cᵢⱼ estimated via a learned generative model GM.

According to embodiment of the invention, the learning loops 202, 204 may be carried out after the blocking step. The learning loops 202, 204 are carried out in parallel to select a set of data points from the dataset U to be annotated by a dedicated entity or resource. For instance, the annotations may be retrieved from a database 212, as shown in FIG. 2.

A first one of the learning loops, which is sometimes referred to herein as fast loop 202, is the front-end learning loop that can be performed online to retrieve annotations from a dedicated entity or resource (e.g., fetching from database 212) per data point with fast speed and short delay. This means that once a selected data point is annotated a retraining process is carried out immediately to update the prediction result P (pᵢⱼ∈P) and uncertainty C (cᵢⱼ∈C) of all remaining data points in U. The fast loop 202 may comprise two major algorithms, including a 1) a query strategy 214 to select the most valuable data point out of U to be annotated (as shown at 228); and 2) a label function (LF) ensemble 216 to predict the matching result and uncertainty of all unlabeled data points based on the voting results of labeling functions in a LF committee 218 (for details, see below) and also the annotated labels A, as shown at 220.

The second one of the learning loops, which is sometimes referred to herein as slow loop 204, is implemented as a background learning loop that is triggered in parallel to automatically create new LFs to augment the LF committee 218 and update their voting results (as shown at 222), accordingly to the latest observation on both the annotated labels A and the predicted weak labels.

The two learning loops 202, 204 are configured to collaborate with each other and to run at different time interval and speeds. The fast loop 202 may be configured to be more computation efficient to be able to perform its prediction cycle per each selected sample under a limited delay. On the other hand, the slow loop 204 could involve more heavy computation with long time interval, for example, training/retraining more advanced machine learning models to make predictions, searching for a best-fit parameter in a large space, etc.

The two learning loops 202, 204 may stop (as shown at 230) until an overall cost is reached. The overall cost may be defined to include two parts: a cost m₁ to annotate the selected samples and a cost m₂ to verify the predicted true matches. An overall gain g may be counted by the total number of true matches captured both from the annotated samples and from the verified true matches.

Embodiments of the present invention may relate to one or more of the following aspects:
a) Adaptive blocking, for instance based on change point detection, to reduce candidates but still keep high recall;
b) Selecting data points in the fast loop based on both diversity and class imbalance;
c) Selecting and weight labeling functions in the fast loop based on both performance metrics and coverage;
d) Automatically tuning the threshold of tunable labeling functions according to updated labels, including both annotated labels and predicted weak labels.

According to an embodiment, the present invention provides a method for efficient ontology matching with a set of initially provided labeling functions and a set of selected distance features, the method comprising the steps of
1) using an adaptive blocking based on change point detection to select a set of likely matched samples (related to the above aspect a.);
2) selecting one sample based on a number of positive votes and uncertainty given by the LF committee (related to the above aspect b.);
3) receiving the annotated label of this selected sample from a technical system (e.g. a database);
4) selecting a set of labeling functions out of the LF committee based on their estimated results against the annotated data set (related to the above aspect c.);
5) adjusting the weight of the selected LFs to produce the predicted results and uncertainty of remaining samples based on the annotated data set (related to the above aspect c.); and
6) triggering a parallel learning loop to create automatically tuned LFs and add them into the LF committee (related to the above aspect d.).

Steps 2)-6) may be continued until the total amount of annotation and verification effort is reached according to the current estimation. The final predicted result may be given to the domain expert for further verification.

### Adaptive Blocking

The goal of the blocking by adaptive blocking component 210 is to reduce as many candidates as possible without missing any true matches so that only a small number of candidates is passed to the next learning phase and both the fast loop 202 and the slow loop 204 can be done efficiently with lower computation overhead. Existing blocking methods either rely on a user-defined threshold on some selected distance feature to select candidates or may require some labeled data to train a blocking model with high recall to do the candidate selection. According to an embodiment of the present invention, the adaptive blocking component 210 of ontology matching system 200 may implement an adaptive blocking algorithm to select matching candidates with high recall and reduction rate, without any labeled data or threshold tuning.

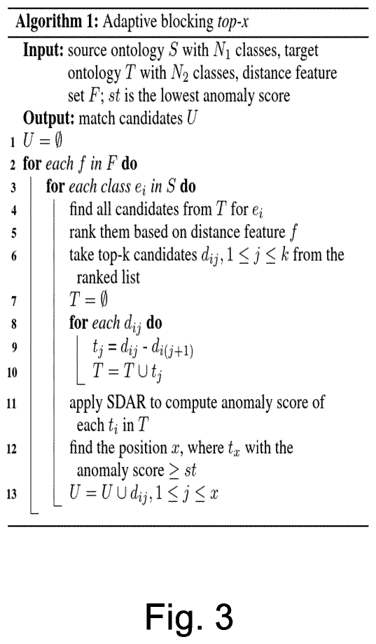

More specifically, the adaptive blocking method may be based on change point detection, which is usually used to detect change points or anomaly out of time series data. Hereinafter, the steps of such an approach in accordance with embodiments of the invention are described in detail. Details of an adaptive blocking approach are also illustrated in the exemplary algorithm (called “top-x”) shown in FIG. 3.

For any given class eᵢ from source ontology S, all candidates eⱼ (1≤j≤N₁) from target ontology T may be ranked based on some distance feature. On top of the ranked candidate, the distance decrease of two neighboring candidates eⱼ and eⱼ₊₁ may be calculated. All those distance decreases form a sequence of distance loss and then a change point detection algorithm may be applied to identify where the largest drop is located in this sequence. While eventually both offline and online change point detection can be applied, online change point detection works better than offline methods in general. In the end, the sequentially discounting autoregression time series modelling, called SDAR (as described, e.g., in Takeuchi, J.-I.; and Yamanishi, K. 2006. A unifying framework for detecting outliers and change points from time series. IEEE transactions on Knowledge and Data Engineering 18 (4): 482-492, which is incorporated herein by reference in its entirety), may be utilized to generate an anomaly score for each data point.

Inventors evaluated adaptive blocking with two additional metrics: recall and reduction. Assume that tp, fp, tn, fn represent the number of true positive, false positive, true negative, false negative samples after the blocking process, recall and reduction were defined as recall=tp/(tp+fp) and reduction=(tp+fp)/(tp+fp+tn+fn). The results over three datasets are listed in the following table, together with the number of candidates and matches before and after the blocking process.

TABLE
Results of adaptive blocking over three datasets

| Dataset | #Candidates | #Matches | Recall | Reduction |
|---|---|---|---|---|
| Conference | 5047/2200 | 11/11 | 100% | 56.4% |
| AI4EU | 41492/4871 | 17/17 | 100% | 88.3% |
| AirTraffic | 140910/8031 | 32/32 | 100% | 94.3% |

It can be seen that the adaptive blocking approach according to embodiments of the present invention achieves 100% recall in all 3 datasets and 94% reduction in the largest dataset. Notice that the larger the dataset is, the higher reduction can be achieved. More importantly, with 100% recall one would not miss out any true matches for the subsequent learning phase.

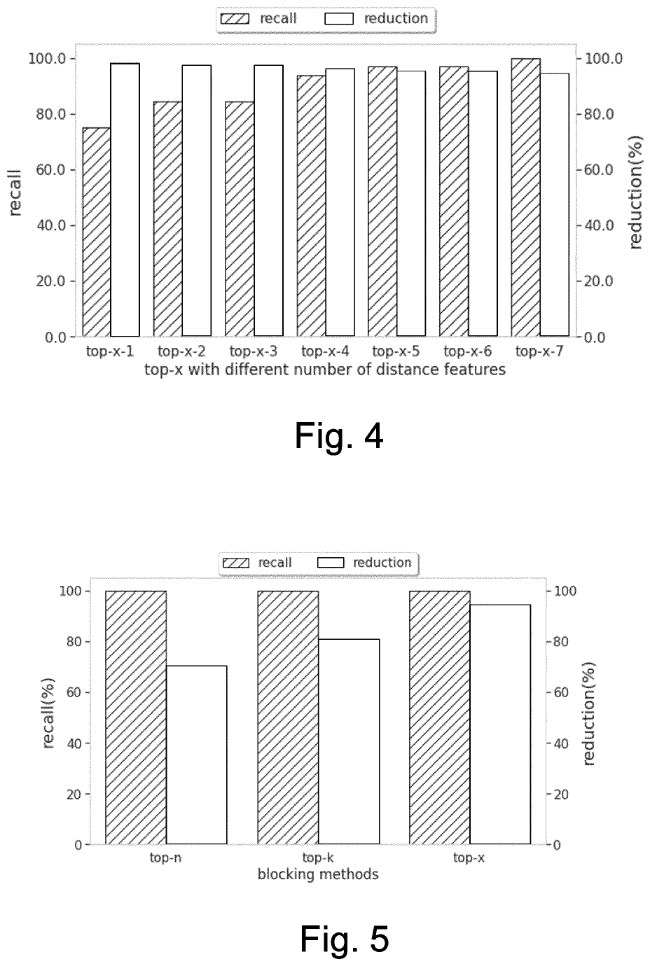

As a more detailed analysis, FIG. 4 shows how recall can be significantly improved by applying top-x to more distance features with only a small loss of the reduction rate. In the end 7 features are included: 6 features are calculated from 3 attributes (class name, label, comment) with 2 different sizes of sentence transformer models (“distilbert-base-nli-mean-tokens” and “paraphrase-MiniLM-L6-v2”), and 1 is calculated based on the number of common words used in the class names of eᵢ and eⱼ. FIG. 5 further shows the comparison results with two baseline approaches: top-n and top-k, in which n and k are selected in a safe manner to achieve 100% recall. It can been seen that top-x can increase the candidate reduction rate from 70% (top-n), 80% (top-k) to 95%. This helps to reduce computation overhead and, if applicable, response time of engaging the domain expert in the subsequent interactive learning phase.

### Sample Query Strategy

The aim of query strategy 214 is to select a valuable sample from the dataset U to be annotated by a dedicated source or entity (e.g. a database or domain expert). The challenging issue is how to use the annotation budget carefully in order to balance the opportunity of gaining annotated labels to learn something new and the risk of losing too much budget for nothing. Several sample query methods have been proposed in the state of the art, such as sample uncertainty and query-by-committee, however, all of them fail to deal with the extreme imbalanced data that one faces in the ontology matching problem. According to embodiments of the present invention, a more efficient query strategy 214 is introduce that considers both the sample diversity for exploring new learning opportunity and the data imbalance for reducing the risk.

According to an embodiment, the query strategy 214 may utilize the following information for each data point in the dataset U:
1) the voting results vᵢⱼ^{q} (1≤ q≤ m) from the initial set of LFs 224 {If₁, lf₂, . . . , lfₘ}, e.g. as provided by the domain expert with low effort, and vᵢⱼ^{q} could be 0 for non-match, 1 for match, or −1 for abstain.
2) the predicted result pᵢⱼ and calculated uncertainty cᵢⱼ given by the LF ensemble model 216, which is introduced in the following section.

Overall, the query strategy 214 breaks the sample query process into two levels of selection. First, all samples are grouped into different groups based on the number of predicted true votes in vᵢⱼ, and the group with the highest number of true votes will be selected. Second, within the selected group, the sample with the maximal uncertainty cᵢⱼ is picked up for annotation.

### LF Ensemble

According to embodiments of the present invention, the LF ensembler 216 is configured to combine the voting results vᵢⱼ^{q} (1≤q≤m) from a set of labeling functions {lf₁, lf₂, . . . , lfₘ} to predict the matching results P of all data points in U and also estimate the uncertainty C of the predicted results. In the state of the art, Snorkel has introduced a data programming approach to address this problem without knowing any labelled data. However, it is based on two assumptions: 1) all labeling functions may provide an accuracy higher than 50%, which is hard to guarantee in practice; 2) the voting results from each labeling function are equally important for the internal optimization, which ignores the opportunity to differentiate them according to the quality of labeling functions.

Using the small set of annotated data A, the slow loop 204 of the method illustrated in FIG. 2 may relax these two assumptions by providing two types of enhancements on top of the data programming approach. First, a heuristic method may be introduced to select a subset of labeling functions out of the LF committee 218 based on A. This way one can exclude some labeling functions that might make negative contributions to the LF ensemble 216. Second, it is possible to estimate the precision of the selected LF based on A and then adjust the weight of each selected LF based on its estimated precision for training the LF ensemble model.

### LF Augmentation

For the purpose of simplicity, the initial LFs 224, e.g. provided by the domain expert, usually have a very simple logic and are easy to program. Their performance turns to be conservative, meaning that they either cover some cases with high certainty or use some safe distance threshold to select highly likely matches. However, the entire fast loop 202 lacks the capability to explore and discover new true matches as the interaction with the domain expert continues. Therefore, embodiments of the present invention introduce the slow loop 204 to augment the LF committee 218 with some newly generated LFs 226, which could take a relatively brave step to cover more likely true matches gradually. This helps to break the deadlock situation that many existing active learning approaches are facing.

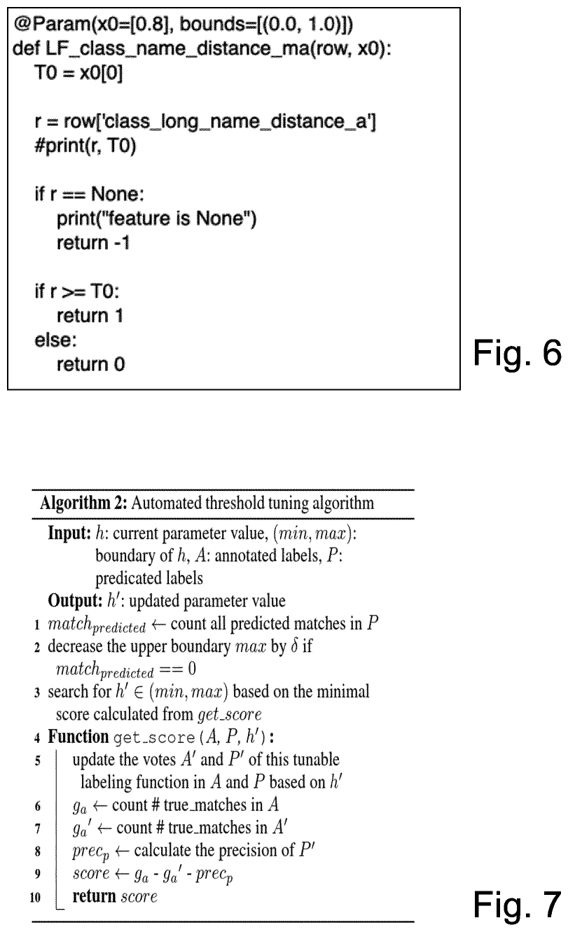

According to embodiments of the present invention, tunable labeling functions may be introduced to create/update new LFs on the fly by automatically tuning some distance-related threshold, based on the latest annotation data A and prediction results P. The newly created or updated LFs 226 will be included into the LF committee 218 to influence the fast loop 202 by providing more likely true matches or reducing the prediction precision with lower false positive matches. An embodiment of a tunable labeling function based on the distance feature calculated from a class name is exemplarily illustrated in FIG. 6.

According to embodiments of the invention, each tunable labeling function may rely on a tunable threshold parameter h and some similarity feature s to decide whether a candidate dᵢⱼ in U is a match or not based on a simple logic. For example, dᵢⱼ is a match if s≥h, otherwise is a non-match. The following methods may be used (alone or in combination with each other) to measure the similarity of dᵢⱼ:
1. Using pre-trained sentence transformer models (e.g., Sentence-BERT) to measure the semantic similarity of string-based attributes (e.g., class name, label, or comments) of classes eᵢ, eⱼ. This method allows to measure the similarity of dᵢⱼ based on a single string-based attribute without any training.
2. Using the predicted matching probability of a machine learning model that is trained/retrained from all prepared features based on the latest results of A and P. This method allows to measure the similarity of dᵢⱼ based on the entire feature set by training/retraining a machine learning model.
3. Using the knowledge graph embedding models that are trained/retrained from a temporary graph G that combines S, T, and also all annotated and predicted matches as new edges represented between S and T. With this updated graph embedding models, it is possible to calculate the embedding of each node and further measure the similarity of two classes eᵢ, eⱼ. This method allows to measure the similarity of dᵢⱼ based on the hierarchical structure of classes (e.g., subclasses, superclasses) by training/updating a knowledge graph embedding model.

By tuning the threshold parameters h of tunable LFs and including them into the LF committee 218, ontology matching system 200 is able to discover and propose new matched candidates, which may be used, e.g., to engage the domain expert in the fast loop 202.

FIG. 7 shows an example of an automated threshold tuning approach of tuning h per LF. According to the illustrated embodiment, the approach may include the following steps: 1) calculate the performance of the latest prediction P; 2) search for a new parameter h′ in the specified range of this tunable parameter to make sure that the new parameter h′ can lead to some increase of predicted positive true matches and/or the decrease of predicted negative true matches; 3) apply the new parameter h′ to produce the new voting results of this tunable labeling function and add it into the LF committee 218 for the fast loop 202.

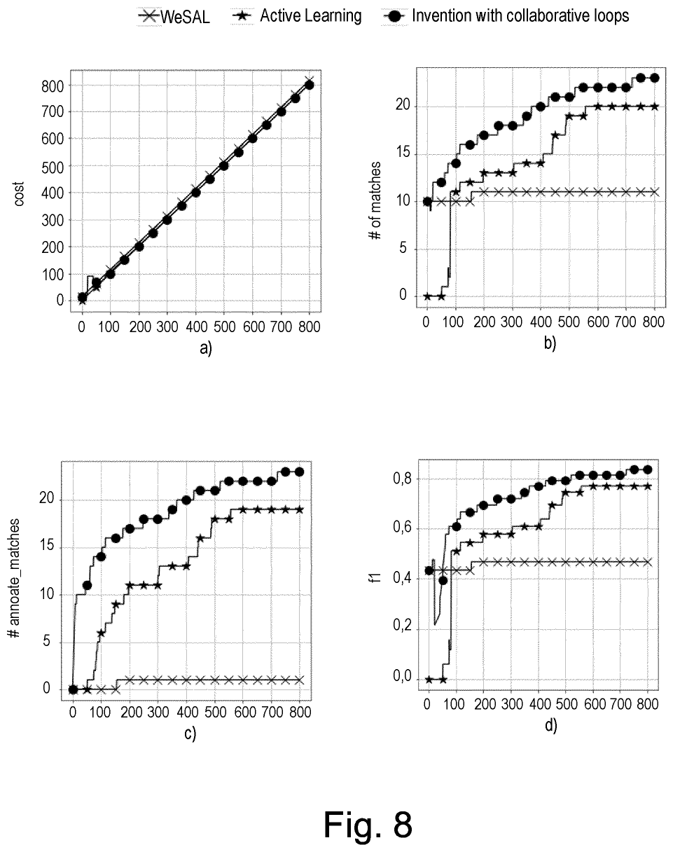

Inventors examined the overall performance of ontology matching in accordance with the present invention with both loops together. FIG. 8 shows the cost and number of matches for three different approaches in the first 800 iterations over the AirTraffic dataset. Notice that Active Learning is able to learn and gain some true matches after the first 60˜80 iterations. WeSAL (for reference, see Nashaat, M.; Ghosh, A.; Miller, J.; and Quader, S. 2020b. WeSAL: Applying active supervision to find high-quality labels at industrial scale. In Proceedings of the 53rd Hawaii International Conference on System Sciences) has a big gain at the beginning but it quickly gets stuck and finds only one more match in the first 800 iterations. In contrast, the method according to the present invention not only has a quick and big gain at the beginning like WeSAL but also is able to capture more true matches gradually with the cost lower than the other two. This is mainly due to the help of the new LFs created and updated by the slow loop. There is a temporary cost increase and F1 drop when the slow loop first starts, because a set of new tunable LFs with a default parameter setting are added into the LF committee and they significantly increase the number of possible matches. After that, one can see that the method according to the present invention is able to automatically tune the thresholds of the newly added labeling functions to improve the precision based on its scoring function. This is why F1 goes up quickly afterwards. More importantly, one can see that with the help from the slow loop, the method according to the present invention is able to capture more matches faster than the other two approaches with slightly lower cost. For example, after the first 400 iterations, the method according to the present invention captures 20 matches, leading to an increase of more than 40% over the other two approaches. Also, the method according to the present invention has a more stable exploring capability than the other two in finding more true matches over the iteration increase.

As will be easily appreciated by those skilled in the art, the present invention can be applied in many different scenarios. Hereinafter, for illustrative purposes, two exemplary use cases will be briefly described, wherein the first use case (Use Case 1) relates to common building metadata for digital twin construction and optimized building control, while the second use case (Use Case 2) relates to a backbone ontology as the basis for data sharing platforms across industries and companies. Adaptations to other use cases not explicitly mentioned herein are straightforward.

### Use Case 1

Buildings account for roughly 40% of all energy consumed in developed countries. Non-residential buildings, such as office buildings account for a large amount of that energy. These buildings consist usually of several sub systems such as for lighting, heating ventilation and air conditioning (HVAC), access control, room booking etc. For each of this sub-systems, different data schemas/ontologies exist that usually originated in the respective sub-systems and might thus using different naming conventions.

In the architecture, engineering and construction/facility management industry, there exists a common standard for Building Information Models (BIM) representation, the namely Industry Foundation Classes (IFC) standard. As the BIM represented in IFC contains various in-depth info of the building, including its structure and materials, it can serve as a good basis towards a digital twin of a building. In this digital twin, the detailed IFC information can be used to perform building simulations and as input to optimally actuate the building components. The problem is that the underlying data schemas/ontologies are not aligned, and thus a digital twin would need to be constructed for each individual building expensively with lots of man hours.

In accordance with embodiments of the present invention, IFC can be used as a backbone ontology that serves as a basis to integrate the data schemas/ontologies of the previously mentioned sub-systems. Application of the present invention will accelerate the integration and with little effort enable a digital twin construction and a more optimal operation of the physical building twin.

### Use Case 2:

Companies are increasingly beginning to build their own internal knowledge graphs as a common interface to their data lakes. Underlying such data lake is, an often custom designed, ontology that defines the data model and representation. This results in different ontologies across different industries and even for companies within the same industry. As long as data stays within a single company and is not linked to other external data sources, this does not represent a problem. However, data sharing and data linking is becoming an important part of increasingly interconnected industries. One current approach is that a data sharing platform/a data marketplace enables companies to exchange data efficiently. As in reality, different ontologies are used across companies, such data sharing is not easily possible without lots of manual alignment effort. In accordance with the embodiment of the present invention, however, an ontology may be chosen as backbone ontology and it may be extended by matching it with the ontologies of the participating companies of the data sharing platform, utilizing domain experts of the respective companies in the active learning loop of the ontology matching system as described herein.

Further application scenarios may relate to digital twin platforms with AI-enabled semantic interoperability, or data linkage platforms, e.g. for SuperCity.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A computer-implemented method for efficient ontology matching between a source ontology and a target ontology, the method comprising:
filtering out, by means of an adaptive blocking mechanism, non-matching pairs of the source ontology and the target ontology, thereby generating an initially unlabeled dataset U of possible matches;
selecting, in each iteration of a first learning loop and based on prediction results and uncertainty from a set of initially provided labeling functions of a labeling function (LF) committee, a data point from the unlabeled dataset U and obtaining an annotation label for the selected data point;
selecting and weighting, in each iteration of the first learning loop, a set of labeling functions out of the LF committee based on their prediction results against the unlabeled dataset U provided with annotation labels so far and adjusting a weight of each of the selected LFs to produce the prediction results and uncertainty of yet unlabeled data points of the unlabeled dataset U based on the data points of the unlabeled dataset U having already annotated a label; and
executing a second learning loop that automatically creates tuned labeling functions and augments the LF committee with the tuned labeling functions.

2. The method according to claim 1, wherein the second learning loop is implemented as a background learning loop that runs in parallel and collaboratively with the first learning loop.

3. The method according to claim 1, wherein the first learning loop and the second learning loop are terminated upon reaching an overall cost comprising a first cost component related to an annotation of the selected data points and a second cost component related to a verification of predicted true matches.

4. The method according to claim 1, wherein the adaptive blocking mechanism uses a change point detection algorithm applied to a sequence of data points ranked according to a predefined distance feature.

5. The method according to claim 1, wherein selecting data points from the unlabeled dataset U in the first learning loop is based on both unlabeled sample diversity and class imbalance.

6. The method according to claim 1, wherein the unlabeled dataset U is generated such that each data point of the unlabeled dataset U is an initially unlabeled data point dᵢⱼ comprising a predicted result pᵢⱼ that an element eᵢ of the source ontology matches with an element e of the target ontology and a prediction uncertainty cᵢⱼ associated with the predicted result estimated via a learned generative model.

7. The method according to claim 6, wherein the selecting, in each iteration of the first learning loop and based on prediction results and uncertainty from the set of initially provided labeling functions of the labeling function (LF) committee, a data point from the unlabeled dataset U comprises:
grouping the data points dᵢⱼ of the unlabeled dataset U into a number of different groups based on a number of predicted true votes from the set of initially provided labeling functions;
selecting the group with the highest number of true votes and, within the selected group, picking up for annotation the data point having the highest uncertainty cᵢⱼ.

8. The method according to claim 1, further comprising:
combining, by an LF ensembler component, voting results vᵢⱼ^{q}(1≤q≤m) from a set of labeling functions {lf₁, lf₂, . . . , lfₘ} to predict matching results of all data points of the unlabeled dataset U and to estimate an uncertainty of the predicted results.

9. The method according to claim 8, wherein the LF ensembler component further executes the steps of;
applying a predefined heuristic to select a subset of labeling functions out of the LF committee based on the annotation data obtained so far; and
estimating precision of the labeling functions of the selected subset based on the annotation data obtained so far and then adjusting the weight of each labeling function of the selected subset based on the estimated precision for training of a learning model associated with the LF ensembler component.

10. The method according to claim 1, wherein the creation of tuned LFs comprises a generation of new LFs and/or an update of already existing LFs.

11. The method according to claim 1, wherein tunable labeling functions are used to create new labeling functions and/or to update already existing labeling functions on the fly by automatically tuning a predefined distance-related threshold based on latest annotation data and prediction results.

12. The method according to claim 11, wherein each tunable labeling function relies on a tunable threshold parameter and a predefined similarity feature to decide whether a candidate dᵢⱼ in the unlabeled dataset U is a match or not based on a predefined logic.

13. The method according to claim 12, wherein the predefined similarity feature measures similarity based on:
using a pre-trained sentence transformer model measuring a semantic similarity of string-based attributes of the classes eᵢ, eⱼ,
using a predicted matching probability of a machine learning model that is trained/retrained from all prepared features based on the latest annotation data and prediction results, and/or
using a knowledge graph embedding model that is trained/retrained from a temporary graph that combines the source ontology and the target ontology as well as new edges represented by all annotated and predicted matches.

14. A system for efficient ontology matching between a source ontology and a target ontology, the system comprising one or more processes that, alone or in combination, are configured to provide for the execution of the following steps:
filtering out, by an adaptive blocking mechanism, non-matching pairs of the source ontology and the target ontology, thereby generating an initially unlabeled dataset U of possible matches;
selecting, in each iteration of a first learning loop and based on prediction results and uncertainty from a set of initially provided labeling functions of a labeling function (LF) committee, a data point from the unlabeled dataset U and obtaining an annotation label for the selected data point;
selecting and weighting, in each iteration of the first learning loop, a set of LFs out of the LF committee based on their prediction results against the unlabeled dataset U provided with annotation labels so far and adjusting a weight of each of the selected LFs to produce the prediction results and uncertainty of yet unlabeled data points of the unlabeled dataset U based on the data points of the unlabeled dataset U having already annotated a label; and
executing a second learning loop that automatically creates tuned LFs and augments the LF committee with the tuned LFs.

15. A, non-transitory computer-readable medium having instructions thereon which, upon being executed by one or more processors, alone or in combination, provide for execution of a method comprising:
filtering out, by means of an adaptive blocking mechanism, non-matching pairs of the source ontology and the target ontology, thereby generating an initially unlabeled dataset U of possible matches;
selecting, in each iteration of a first learning loop and based on prediction results and uncertainty from a set of initially provided labeling functions of a labeling function (LF) committee, a data point from the unlabeled dataset U and obtaining an annotation label for the selected data point;
selecting and weighting, in each iteration of the first learning loop, a set of LFs out of the LF committee based on their prediction results against the unlabeled dataset U provided with annotation labels so far and adjusting a weight of each of the selected LFs to produce the prediction results and uncertainty of yet unlabeled data points of the unlabeled dataset U based on the data points of the unlabeled dataset U having already annotated a label; and
executing a second learning loop that automatically creates tuned LFs and augments the LF committee with the tuned LFs.
